(19) United States
(12) Patent Application Publication
(10) Pub. No.: US 2010/0226712 A1
(43) Pub. Date: Sep. 9, 2010

(54) APPLIANCE CLAMPING BUSH AND APPLIANCE CLAMPING DEVICE USING THE SAME

(76) Inventors: Takao Kuroki, Hyogo (JP); Satoru Yamamoto, Tokyo (JP)

Correspondence Address: BIRCH STEWART KOLASCH & BIRCH, PO BOX 747, FALLS CHURCH, VA, 22040-0747, US

(21) Appl. No.: 12/600,180

(22) PCT Filed: Jan. 28, 2008
(86) PCT No.: PCT/JP2008/051211

§ 371 Date: Nov. 13, 2009

(30) Foreign Application Priority Data
May 17, 2007 (JP) 2007-131873

(51) Int. Cl. F16B 5/06

(52) U.S. Cl. 403/291

(57) ABSTRACT

In a bush to be used when an appliance is installed on another member, the bush includes an outer peripheral side elastic component 2 made of a plastic material, composed of a central portion 2a attached to the casing 12 of the appliance by a tap screw 5 and an outer peripheral portion 2c formed integral with the central portion 2a through a clearance 6 provided therebetween and having a flexure allowance L; and an inner peripheral side elastic component 3 made of a rubber elastic material having hardness lower than that of the outer peripheral side elastic component 2, and assembled into the clearance 6 of the outer peripheral side elastic component 2.

### TECHNICAL FIELD

The present invention relates to an appliance clamping bush for use in mounting an appliance on another member and an appliance clamping device using the bush.

### BACKGROUND ART

When an appliance is mounted on a member, it is often the case with the mounting portion where a bush is interposed. For example, when an on-vehicle appliance or the like is mounted on the side of a vehicle, a bush is interposed between the on-vehicle appliance and the vehicle. In order to warrant simplification of the structure of the mounting section and facilitation upon attachment of the appliance to the vehicle, a bush is frequently used with a structure in which the peripheral portion of the casing of the on-vehicle appliance or the like is covered with a bush made of a single rubber material or a bush made of a single plastic material. Further, the bushes include a bush made of only metal.

In the case of a bush made of a single rubber material, the bush cannot absorb vibration because of its excessive flexibility, but tends to amplify vibration acceleration. Moreover, in the case of a bush made of a single plastic material or a metal bush, vibration is substantially directly transmitted because of its excessive hardness, and the absorption of vibration cannot be expected therefrom. Furthermore, in the case of a metal bush, the bush can even produce slapping sound due to its hardness, which is peculiar to metal. Thus, when any of a bush made of a single rubber, a bush made of a single plastic, and a metallic bush is employed, there is a problem that abnormal noise by vibration is produced. For this reason, e.g. a shock-absorbing bush used for a suspension of a motor vehicle is disclosed in Patent Document 1 as a bush having shock-absorbing characteristics.

Patent Document 1: JP-A-2004-068827

However, in the bush disclosed in Patent Document 1, a shock-absorbing or buffer section made of a rubber material receives a load, and thus when an on-vehicle appliance or the like is mounted on the side of a vehicle, the bush cannot be used as with the case of using a bush made of a single rubber material. Further, when an appliance is installed on a member (instrument panel or the like) having a vibration source as in a vehicle or the equivalent, since it is necessary to prevent resonance with the vibration from the vibration source, sometimes a single buffer material cannot cope with the problem.

In view of such a technical situation, the present invention is made, and an object of the present invention is to provide a bush to be used when an appliance is mounted to another member and a structure of a clamping device using the bush, such that the bush and the structure are capable of absorbing wider transmission of vibration and preventing amplification of vibration.

### DISCLOSURE OF THE INVENTION

The appliance clamping bush according to the present invention is a bush to be used when an appliance is installed on another member, wherein the bush includes an outer peripheral side elastic component made of a plastic material, the elastic component being composed of a central portion attached to the appliance or the member by a core material and an outer peripheral portion which is formed integral with the central portion through a clearance therebetween and has a flexure allowance; and an inner peripheral side elastic component made of a rubber elastic material having hardness lower than that of the outer peripheral side elastic component, and assembled into the clearance of the outer peripheral side elastic component.

Further, the appliance clamping device according to the present invention includes the above-described appliance clamping bush and a support section which is attached to the member or the appliance, and into which the outer peripheral portion of the outer peripheral side elastic component in the appliance clamping bush is force-fitted.

According to the appliance clamping bush and the appliance clamping device according to the present invention, the outer peripheral side elastic component and the inner peripheral side elastic component, which are different from each other in elasticity, are combined with each other. Thus, the bush or the device can be adjusted to have a variety of elasticities, and the transmission of vibration in a wider range (resonance frequency region) can be absorbed to thus suppress the amplification of the vibration. As a result, the production of vibration abnormal noise can be restrained.

### BRIEF DESCRIPTION OF THE DRAWINGS

FIG. 1 shows an appliance clamping bush in accordance with the first embodiment of the present invention: (a) is a longitudinal sectional view thereof; (b) is a transverse sectional view thereof, and the section taken along the line A-A thereof is shown by a longitudinal sectional view of (a); and (c) is a plan view thereof.

FIG. 2 shows an audio system which is an example of the appliance to which the first embodiment of the invention is applied: (a) is a plan view thereof; (b) and (c) are lateral plan views thereof; and (d) is a front view thereof.

FIG. 3 is an exploded perspective view showing the procedure for attaching the appliance clamping bush in accordance with the first embodiment to an audio system.

FIG. 4 is a perspective view of a state where the appliance clamping bush in accordance with the first embodiment is attached to the audio system.

FIG. 5 shows an appliance clamping bush in accordance with the second embodiment of the present invention: (a) is a longitudinal sectional view thereof; (b) is a transverse sectional view thereof, and the section taken along the line B-B thereof is shown by a longitudinal sectional view of (a); and (c) is a plan view thereof.

FIG. 6 is an exploded perspective view showing the procedure for attaching the appliance clamping bush in accordance with the second embodiment to an audio system.

FIG. 7 is a perspective view of a state where the appliance clamping bush in accordance with the second embodiment is attached to the audio system.

### BEST MODE FOR CARRYING OUT THE INVENTION

Embodiments of the present invention will now be described with reference to the accompanying drawings in order to explain the present invention in more detail.

### First Embodiment

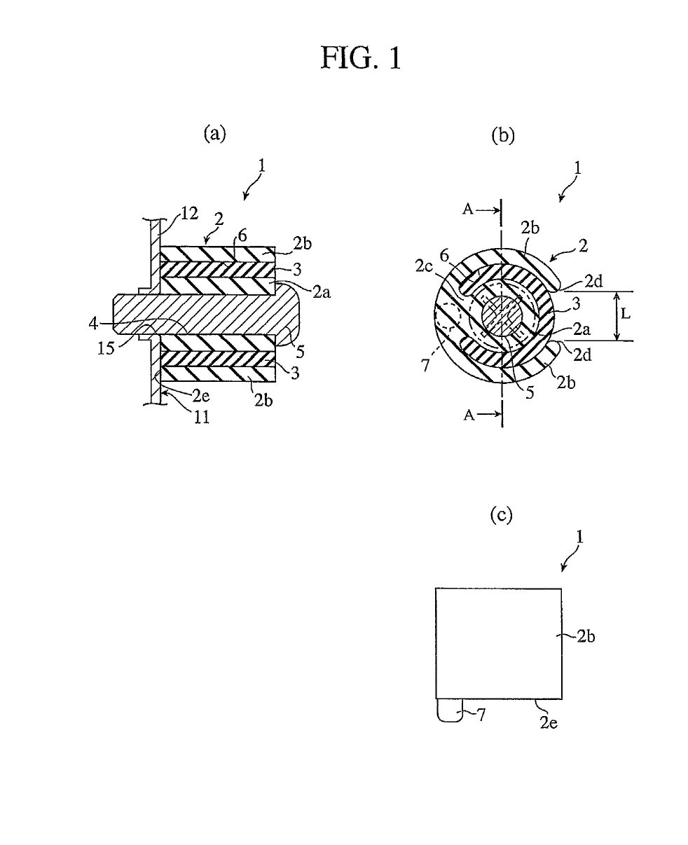

FIG. 1 shows an appliance clamping bush in accordance with the first embodiment of the present invention; FIG. 1 (a) shows a longitudinal section thereof, FIG. 1 (b) shows a transverse section thereof, and the section taken along the line A-A thereof corresponds to FIG. 1 (a). FIG. 1 (c) shows a plan view thereof. It is noted that in the first embodiment the present invention is applied when an audio system as an on-vehicle appliance is installed in an instrument panel on the side of a vehicle.

As shown in FIG. 1 (a) and FIG. 1 (b), an appliance clamping bush 1 includes an outer peripheral side elastic component 2 made of a plastic material, the elastic component consisting of a central portion 2a and an outer peripheral portion 2b; and an inner peripheral side elastic component 3 made of a rubber elastic material and combined with the outer peripheral side elastic component 2. The center section in the central portion 2a of the outer peripheral side elastic component 2 is provided with a through hole 4, where a tap screw (iron core) that is a core material is penetrated. The outer peripheral portion 2b is formed integral via a connection section 2c with the side surface on one side (the left side in the state shown in FIG. 1 (b)) of the central portion 2a of the outer peripheral side elastic component 2, and with a clearance 6 provided between the outer peripheral portion and the outer periphery of the central portion 2a. The outer peripheral portion 2b is not formed in the shape of a complete ring, which is discontinuous, as the clearance 6 is opened on the side opposite from the side where the portion is formed integral with the central portion 2a (on the right side in the state shown in FIG. 1 (b)). In other words, the outer peripheral portion 2b is of two-arc-form so as to place the central portion 2a therebetween, and has a space L between the ends 2d of those arcs. The outer peripheral portion 2b formed in the shape of two arcs is arranged to be able to easily flex inwardly by virtue of the space L. The outer peripheral portion 2b functions like a resilient member, and the space L between the ends 2d of the outer peripheral portion 2b gives a flexure allowance.

The inner peripheral side elastic component 3 is formed in the shape of a cutaway cylinder which is a cylinder from which the portion corresponding to the connection section 2c of the outer peripheral side elastic component 2 is cut away, and is inserted and assembled into the clearance 6 of the outer peripheral side elastic component 2. The inner peripheral side elastic component 3 is made of a rubber elastic material softer than the plastic material forming the outer peripheral side elastic component 2. Therefore, the outer peripheral portion 2b is adapted to elastically compress the inner peripheral side elastic component 3 to be flexible. A variety of elastic materials can be employed for the plastic material forming the outer peripheral side elastic component 2 and the rubber material forming the inner peripheral side elastic component 3. Thus, the combination of hard plastic materials and soft rubber materials can produce the appliance clamping bush having a variety of elasticities (attenuation characteristics).

The appliance clamping bush 1 is constructed of the two elastic components (the outer peripheral side elastic component 2 and the inner peripheral side elastic component 3) in combination, and moreover, the vibration damping property thereof is different from one diametrical position to another. Thus, the appliance clamping bush should be attached thereto in a predetermined state in order to have a predetermined damping property. Therefore, a surface 2e on the side of the outer peripheral side elastic component 2, which is applied to an appliance, is provided with a positioning protrusion 7. The positioning protrusion 7 is adjusted to a positioning hole provided in the casing of the appliance. The positioning device is thus provided thereon, which causes the appliance clamping bush 1 to take a fixed attitude in the attached state. In this connection, those positioning protrusion 7 and positioning hole are in a relative relation, and thus it is also possible to provide a concavity on the side of the bush and provide the protrusion on the side of the appliance.

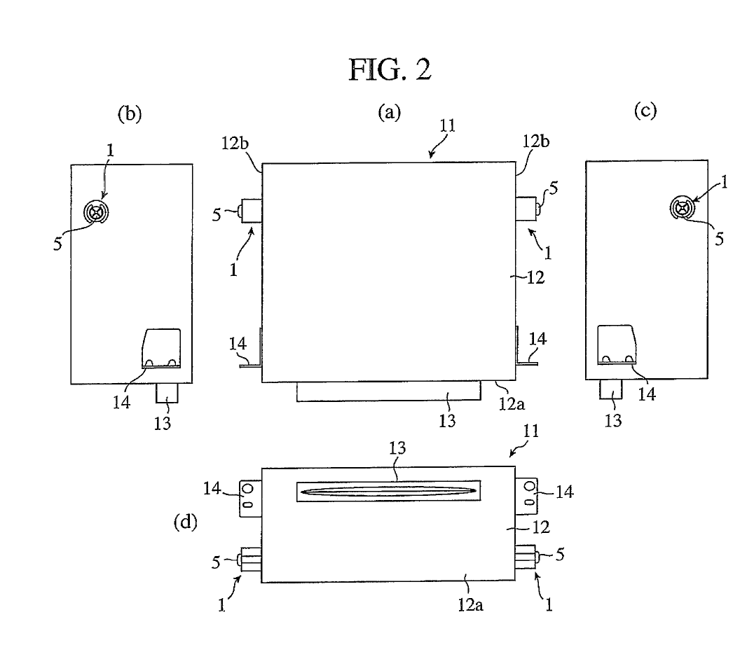

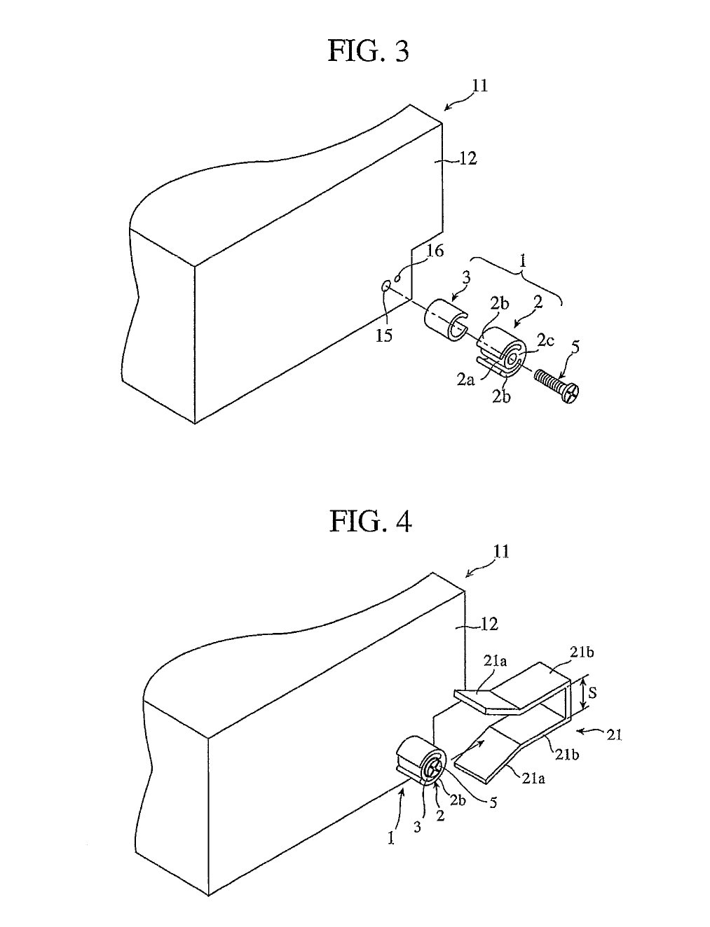

FIG. 2 shows an on-vehicle audio system 11 which is an example of the appliance to which the appliance clamping bush 1 in accordance with the first embodiment is applied and attached. FIG. 2 (a) is a plan view thereof, FIG. 2 (b) and FIG. 2 (c) are left and right lateral plan views thereof, respectively, and FIG. 2 (d) is a front view thereof. FIG. 3 and FIG. 4 show the procedure for attaching the appliance clamping bush 1 to the audio system 11. The front face 12a of the casing 12 of the audio system 11 is provided with a loading slot 13 for a CD. The front of the two sides 12b of the casing 12 is provided with a mounting bracket 14. The lower rear portion of the two sides 12b of the casing 12 is provided with a bush mounting hole 15. A positioning hole 16 into which the positioning protrusion 7 of the appliance clamping bush 1 is inserted is provided in the vicinity of the bush mounting hole 15.

The appliance clamping bush 1 is constructed in the combination of the outer peripheral side elastic component 2 made of a plastic material and the inner peripheral side elastic component 3 made of a rubber material, which are both molded separately from each other; however, the appliance clamping bush may be fabricated by so-called “two-color molding.” To be more specific, the inner peripheral side elastic component 3 previously molded is placed in a mold for the outer peripheral side elastic component 2, and when the outer peripheral side elastic component 3 is molded, the molding is performed such that the inner peripheral side elastic component 3 is embedded integral in the outer peripheral side elastic component.

As not depicted, the instrument panel of the vehicle is provided with a concavity for assembling the audio system 11 therein. Both the inner side wall surfaces of the concavity each have a support bracket 21 as shown in FIG. 4. The support bracket 21 is generally U-shaped, the front portion thereof forms an inclined section 21a which is vertically openable, and the next following portion forms a support section 21b. The space S between the support sections 21b is designed smaller than the diameter of the outer peripheral portion 2b of the outer peripheral side elastic component 2 in the appliance clamping bush 1.

In the case where the appliance clamping bush 1 is assembled to the audio system 11, in the first place, the inner peripheral side elastic component 3 is assembled into the clearance 6 of the outer peripheral side elastic component 2 as shown in FIG. 1 and FIG. 3, thus combining the two components into a unit. As described above, when an integral one of the outer peripheral side elastic component 2 and the inner peripheral side elastic component 3 is employed, which has been previously molded as a unit from the beginning, the integral unit can be prepared. Subsequently, the positioning protrusion 7 formed on the outer peripheral side elastic component 2 is fitted into the positioning hole 16 provided in the side 12b of the casing 12, then the tap screw 5 is passed through the through hole 4 provided through the central portion 2a of the outer peripheral side elastic component 2, and further the tap screw is screwed into the mounting hole 15 of the casing 12 to be tightened against the casing. The appliance clamping bush 1 is fixed to the casing 12 by screwing the tap screw 5 into the mounting hole 15 and tightening it thereon. The appliance clamping bush 1 is positioned in a circumferential direction by its positioning protrusion 7 and the positioning hole 16 provided on the side of the casing 12, and thus the appliance clamping bush is mounted on the side 12b of the casing 12 in a predetermined attitude.

Next, the casing 12 is inserted and forced into the appliance holding concavity of the instrument panel. The outer peripheral portion 2b of the outer peripheral side elastic component 2 of the appliance clamping bush 1 is forced between the support sections 21b of the support bracket 21 through the inclined portion 21a thereof, and thereby, is press fitted between the support sections 21b. The outer peripheral portion 2b is provided with the flexure allowance L, and thus the flexure allowance L allows the outer peripheral portion 2b to be elastically deformed upon press-fitting. After press-fitting the appliance clamping bush 1 into the support bracket 21, the mounting bracket 14 on the front of the casing 12 is clamped to the side of the instrument panel by a screw or the equivalent. As stated above, attachment of the audio system 11 to the instrument panel is completed.

According to the appliance clamping bush and the appliance clamping device in accordance with the first embodiment, the back of the audio system 11 is secured to the side of the instrument panel by simply inserting and press fitting the audio system 11 into the concavity on the side of the instrument panel, and thus installation work thereof is excellently facilitated. The audio system 11 is supported by the two-layer elastic structure constructed by combining the two types of elastic materials (the outer peripheral side elastic component 2 and the inner peripheral side elastic component 3), and thus the clamping device can absorb wide range vibration to be received from a vehicle and can suppress the amplification of the vibration. Thus, the generation of vibration abnormal noise from the audio system 11 can be restricted. Further, selection of materials for the outer peripheral side elastic component 2 and the inner peripheral side elastic component 3, namely, the adjustment of the elasticity of the two types of elastic members can produce the optimum vibration absorption characteristics against the vibration the audio system 11 receives therefrom.

### Second Embodiment

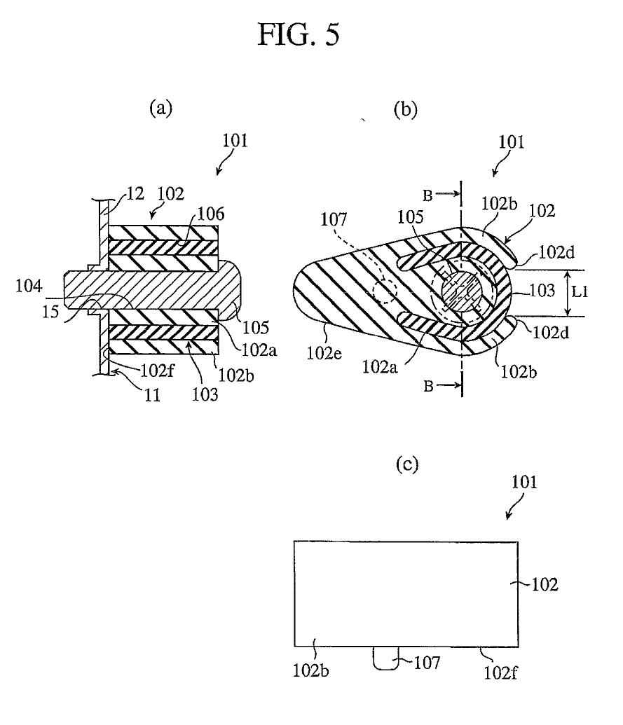

The second embodiment of the present invention will next be discussed by reference to the drawings in detail. FIG. 5 shows an appliance clamping bush in accordance with the second embodiment; FIG. 5 (a) shows a longitudinal sectional view thereof, FIG. 5 (b) shows a transverse sectional view thereof, and the section taken along the line B-B thereof corresponds to FIG. 5 (a). FIG. 5 (c) shows a plan view thereof. It is noted that also in the second embodiment as is the case with the first embodiment, the present invention is applied when an audio system as an on-vehicle appliance is installed in an instrument panel on the side of a vehicle.

As shown in FIG. 5 (a) and FIG. 5 (b), an appliance clamping bush 101 includes an outer peripheral side elastic component 102 made of a plastic material and composed of a central portion 102a and an outer peripheral portion 102b; and an inner peripheral side elastic component 103 made of a rubber elastic material and combined with the outer peripheral side elastic component 102. The center section in the central portion 102a of the outer peripheral side elastic component 102 is provided with a through hole 104, where a tap screw (iron-core member) 105 that is a core material is passed through. The outer peripheral portion 102b is formed integral via a connection section 102c with the side surface on one side (the left side in the state shown in FIG. 5 (b)) of the central portion 102a of the outer peripheral side elastic component 102, and with a clearance 106 provided between the outer peripheral portion and the outer periphery of the central portion 102a. The outer peripheral portion 102b is not formed in the shape of a complete ring, which is discontinuous, as the clearance 106 is opened, on the side opposite from the side where the portion is formed integral with the central portion 102a (on the right side in the state shown in FIG. 5 (b)). Specifically, the outer peripheral portion 102b is of two-arc-form so as to place the central portion 102a therebetween, and has a space L1 between the ends 102d of those arcs. The outer peripheral portion 102b having a two-arc shape is adapted to be able to easily flex inwardly by virtue of the space L1. The outer peripheral portion 102b functions like a resilient material, and the space L1 between the end portions 102d gives a flexure allowance.

The connection section 102c and the outer peripheral portion 102b of the outer peripheral side elastic component 102 further laterally extend integral with each other, and gradually narrow or diminish its cross-section to form a guide section 102e. The guide section 102e functions as a guide when the appliance clamping bush 101 is force-fitted into the support bracket 21 on the side of the instrument panel discussed in the first embodiment. In this connection, since the outer peripheral side elastic component 102 expands in one direction, the clearance 106 provided between the central portion 102a and the outer peripheral portion 102b also extends toward the side of the guide section 102e.

The inner peripheral side elastic component 103 is formed in the shape of a cutaway cylinder (the shape of a horseshoe) such that the portion corresponding to the connection section 102c in the outer peripheral side elastic component 102 is removed, and is inserted into the clearance 106 of the outer peripheral side elastic component 102 to be assembled thereto. The inner peripheral side elastic component 103 is made of a rubber elastic material softer than the plastic material forming the outer peripheral side elastic component 102. Thus, the outer peripheral portion 102b is arranged to be able to elastically compress the inner peripheral side elastic component 103 to flex. A variety of elastic materials can be employed for the plastic material forming the outer peripheral side elastic component 102 and the rubber material forming the inner peripheral side elastic component 103. Thus, the combination of hard plastic materials and soft rubber materials can give the appliance clamping bush having a variety of elasticities (attenuation characteristics).

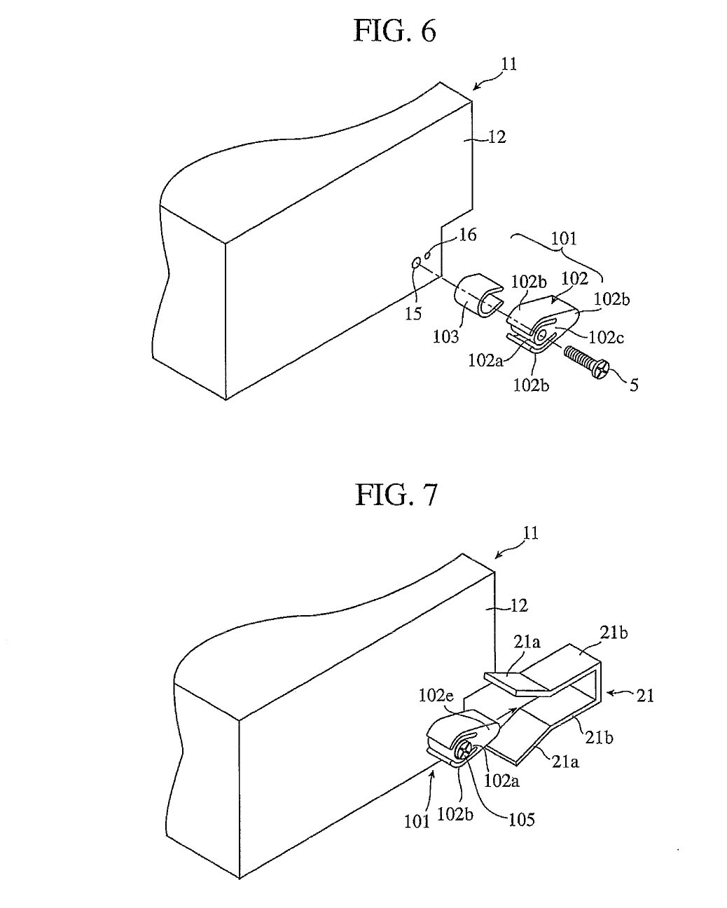

The appliance clamping bush 101 is constructed of the two elastic components (the outer peripheral side elastic component 102 and the inner peripheral side elastic component 103) in combination, and moreover, the vibration damping properties thereof vary depending on diametrical locations. Thus, the appliance clamping bush should be attached in a predetermined state in order to obtain a predetermined damping property. For this reason, a surface 102f on the side applied to an appliance in the outer peripheral side elastic component 102 is provided with a positioning protrusion 107. The positioning protrusion 107 is fitted into a positioning hole 16 (see FIG. 6) provided on the side 12b of the casing 12 of the audio system 11. Thus, the positioning device is provided, which permits the appliance clamping bush 101 to take a fixed attitude in the attached state.

The appliance clamping bush 101 is constructed in the combination of both the outer peripheral side elastic component 102 made of a plastic material and the inner peripheral side elastic component 103 made of a rubber material, which are both molded separately from each other; however, the clamping bush may be fabricated by so-called “two-color molding.” Specifically, the inner peripheral side elastic component 103, which has been previously molded, is placed in a mold for the outer peripheral side elastic component 102, and upon plastic molding of the outer peripheral side elastic component 102, the molding is performed such that the inner peripheral side elastic component 103 is embedded in a unit.

The audio system 11 to which the appliance clamping bush 101 is applied is provided in an instrument panel of a vehicle. A concavity for use in assembling the audio system 11 therein has the same structure as that of the first embodiment, and the concavity has a support bracket 21 provided on the inner surface thereof as shown in FIG. 7. The support bracket 21 has the same structure as that of the bracket showed in FIG. 4, and consists of an inclined section 21a on the inlet side and the subsequent support section 21b.

Next, referring to FIG. 6 and FIG. 7, the procedure for installing the audio system 11 in the instrument panel by the appliance clamping bush 101 will be discussed.

The inner peripheral side elastic component 103 is assembled into the clearance 106 of the outer peripheral side elastic component 102 as shown in FIG. 5 and FIG. 6, thus combining the two components into a unit. As described above, When an integral one of the outer peripheral side elastic component 102 and the inner peripheral side elastic component 103 is employed, which have been previously molded as a unit from the first, the integral unit may be prepared. Subsequently, the positioning protrusion 107 formed on the outer peripheral side elastic component 102 is fitted in the positioning hole 16 provided on the side of the casing 12, then the tap screw 105 is passed through the through hole 104 provided through the central portion 102a of the outer peripheral side elastic component 102, and further, the tap screw is screwed into the mounting hole 15 of the casing 11 to be tightened against the casing. The appliance clamping bush 101 is secured to the casing 12 by screwing the tap screw 105 into the mounting hole 15 and tightening it thereon. The appliance clamping bush 101 is positioned in a circumferential direction by the positioning protrusion 107 and the positioning hole 16, and thus the appliance clamping bush is mounted on the side surface of the casing 12 in a predetermined attitude.

Next, the casing 12 is inserted and forced into an appliance holding concavity of the instrument panel. The guide 102e of the outer peripheral side elastic component 102 of the appliance clamping bush 101 is guided by the inclined sections 21a of the support bracket 21, thus causing the outer peripheral portion 102b to be come into the support sections 21b and be press fitted in the support sections 21b. The guide section 102e is formed integral with the outer peripheral portion 102b, thus enabling the outer peripheral portion 102b to be more easily force-fitted into the support bracket 21. The outer peripheral portion 102b is provided with a flexure allowance L1, and thus the flexure allowance L1 allows the outer peripheral portion 102b to be elastically deformed upon press-fitting. After press-fitting the appliance clamping bush 101 into the support bracket 21, the mounting bracket 14 on the front of the casing 12 is secured to the side of the vehicle by a screw or the like. As stated above, attachment of the audio system 11 to the instrument panel is completed.

According to the appliance clamping bush and the appliance clamping device in accordance with the second embodiment, by simply inserting and press fitting the audio system 11 into the concavity on the side of the instrument panel, the appliance clamping bush 101 provided on the rear portion of the casing 12 is automatically force-fitted into and clamped to the support bracket 21 on the side of the instrument panel, and thus installation thereof is excellently facilitated. Force-fitting of the appliance clamping bush 101 into the support bracket 21 is securely performed by virtue of the guide section 102e being provided on the outer peripheral side elastic component 102. The casing 12 is supported by a two-layer elastic structure constructed of two types of elastic materials (the outer peripheral side elastic component 102 and the inner peripheral side elastic component 103) in combination. Thus, wide range vibration received from the vehicle can be absorbed, and the amplification of the vibration can be prevented. Therefore, vibration abnormal noise can be prevented from being generated from the audio system 11. Selection of materials for the outer peripheral side elastic component 102 and the inner peripheral side elastic component 103, namely, adjustment of the elasticity of the two types of elastic members, can produce the optimum vibration absorption characteristic against the vibration received by the audio system 11.

The elasticity desired for an appliance clamping bush can be obtained by variously adjusting the elasticity of the outer peripheral side elastic components 2, 102 and the inner peripheral side elastic components 3, 103 of the appliance clamping bushes 1, 101 in accordance with the first and second embodiments. Moreover, the elasticity of the bush itself can be changed by suitably designing the shapes (containing the shapes of the clearances 6, 106) of the outer peripheral side elastic components 2, 102 and the inner peripheral side elastic components 3, 103.

It should be understood that the present invention can be applied to not only the installation of an on-vehicle appliance but also the general installation of a common appliance on a member having a noise source. Furthermore, in the first and second embodiments, a case where the appliance clamping bush is attached on the side of an appliance is discussed; however, the appliance clamping bush can be also attached on the side of a member having a vibration source.

### INDUSTRIAL APPLICABILITY

As mentioned hereinabove, the appliance clamping bush according to the present invention is suitable, e.g., for an appliance clamping device for installing an on-vehicle audio system in a vehicle because the bush is fabricated by combining the outer peripheral side elastic component and the inner peripheral side elastic component having an elasticity different from each other, thus enabling the absorption of transmission of vibration in a wider range and the suppression of the amplification of vibration.

1. An appliance clamping bush comprising:
an outer peripheral side elastic component made of a plastic material, composed of a central portion and an outer peripheral portion, and having a flexure allowance in the outer peripheral portion; and
an inner peripheral side elastic component made of a rubber elastic material having hardness lower than that of the outer peripheral side elastic component, and assembled between the central portion and the outer peripheral portion thereof.

2. The appliance clamping bush according to claim 1, where the outer peripheral side elastic component is provided with a positioning device for regulating the position in a circumferential direction.

3. The appliance clamping bush according to claim 1, wherein the outer peripheral side elastic component is provided with a guide section functioning as a guide at the time of assembling.

4. An appliance clamping device comprising:
an appliance clamping bush as recited in claim 1; and
a support section which is provided in an appliance attaching section on the side of a member having a vibration source, and into which the outer peripheral side elastic component of the appliance clamping bush is force-fitted.
